(19) United States
(12) Patent Application Publication
(10) Pub. No.: US 2004/0109809 A1
(43) Pub. Date: Jun. 10, 2004

(54) Method of forming phosphoric acid from phosphate ore

(76) Inventors: Allan E. Hokanson, Cincinnati, OH (US); Derek Williams, Wilmington, NC (US); Christopher S. Williams, Wilmington, OH (US)

Correspondence Address: COATS & BENNETT, PLLC, P O BOX 5, RALEIGH, NC, 27602, US

(21) Appl. No.: 10/315,842

(22) Filed: Dec. 10, 2002

(51) Int. Cl. C01B 25/16

(52) U.S. Cl. 423/318

(57) ABSTRACT

The process disclosed herein involves the high temperature processing of phosphate ore in a solid state using a ported rotary kiln. Prior to insertion into the kiln, the ore is pulverized and beneficiated to remove excessive quantities of unwanted materials such as clay, silica, iron, sodium, potassium, and alumina. The calcium oxide to silica ratio of the beneficiated is then adjusted to within a specific acceptable range, a carbon source containing sulfur such as petroleum coke is added and the resulting feed material is pelletized using a binding agent if necessary. The pelletized feed material is then dried, preheated, and fed into a ported rotary kiln. At the elevated temperature maintained in the reducing kiln, tricalcium phosphate undergoes a reduction reaction to produce phosphorus gas and carbon monoxide. Atmospheric air is injected into the rotating kiln chamber, which facilitates the oxidation of phosphorus gas to phosphorus pentoxide and the oxidation of carbon monoxide to carbon dioxide. The reducing kiln exhaust gas stream containing the phosphorus pentoxide and carbon dioxide gas components is processed in an absorption column in which the phosphorus pentoxide is hydrolyzed by water to phosphoric acid. The phosphoric acid is then recovered and concentrated to a commercial grade strength. The slag residue serves as a raw material for cement manufacture.

### FIELD OF THE INVENTION

This invention relates to the processing of phosphate ore for the recovery of phosphoric acid based on solid state processing of the ore at elevated temperatures.

### BACKGROUND OF THE INVENTION

Phosphoric acid is a chemical compound that has broad application over a wide range of commercial industries. Approximately ninety percent of all commercial grade phosphoric acid is derived from the wet acid process. In this process, hot sulfuric acid is reacted with beneficiated and pulverized ore to produce the desired phosphoric acid. With this process, it is essential that the ore first be beneficiated to remove sand, clay, and silt, otherwise excessive amount of sulfuric acid would be required to facilitate the desired reaction.

As a byproduct of this process, calcium sulfate is precipitated and filtered from the acid solution as gypsum. Each ton of ore processed yields approximately one and one third tons of gypsum. Ordinarily, this byproduct could be used for wallboard and concrete manufacture but the presence of radium in the raw ore and subsequently in the resulting gypsum byproduct seriously reduces its commercial attractiveness of the material for environmental reasons. In the case of Florida, where 70% of domestic phosphate production is located, there are approximately 800 million tons of gypsum stockpiled to date, with an estimated additional 30 million tons entering the stockpile each year. These stockpiles, numbering 27 in Florida with each being about 300 feet in height, occupy 5000 acres. In addition to the problem of contaminated gypsum, another serious environmental problem results from the reaction between sulfuric acid and the calcium fluoride in the ore. Dissolution of the calcium fluoride causes the formation of two gaseous products, namely silicon hexafluoride and hydrogen fluoride. These fluoride compounds become distributed as follows:

| | Percent |
|---|---|
| In gypsum | 10 to 20 |
| In cooling ponds from reactor emissions | 10 to 25 |
| In cooling ponds from phosphoric acid evaporator | 40 to 60 |
| In filter cake from removing HF from phosphoric | 10 to 20 |
| acid by precipitation with lime | |

As a result of disposing of fluorine compounds in cooling water ponds, which range in size from 100 to 500 acres at each of the about eleven phosphate plants in Florida, soluble fluorine compounds in the ponds range from 4000 to 25000 ppm.

Another byproduct of the beneficiation process is the production of slime ponds. The beneficiation process requires large amounts of water, which becomes unsuitable for other uses because of contaminants. This water is then placed into holding ponds where it stagnates and becomes further unusable. Acres of land are thus tied up in these slime ponds and many gallons of water are effectively removed from circulation. These slime ponds provide havens for breeding mosquitoes and are odiferous, further contributing to their undesirability.

Another problem faced by the Florida phosphate industry is the gradual decline in quality of the ore due to the increasing presence of magnesium oxide (MgO). Fluorapatite ore is mined from the earth and typically contains by analysis after beneficiation: calcium oxide (CaO) 48%, phosphorus pentoxide (P₂0₅) 32%, silicon dioxide (SiO₂) 7%, magnesium oxide (MgO) 0.3%, aluminum oxide (Al₂) 0.31%, iron oxide (F₂O₃) 1%, and other minor constituents. Unbeneficiated Florida ore contains about 16% (P₂0₅).

During the wet acid process, magnesium sulfate is often produced. Such magnesium sulfate is soluble in phosphoric acid, and therefore does not precipitate out of solution, as does calcium sulfate. Hence, the magnesium sulfate is often considered a contaminant and therefore the process is limited to the use of ore with less than 1% magnesium oxide. At present, there is no practical and economic way for removing magnesium sulfate from phosphoric acid. As a result, millions of tons of phosphate ore containing dolomite have been mined but have been set aside as unusable.

There is and continues to be a need for a practical and efficient technique for extracting phosphorus from phosphate ore which does not require the use of a highly acidic reagent, does not require extensive beneficiation of the raw ore, does not produce contaminated gypsum byproduct, does not contaminate large acreage cooling water ponds at the phosphate plants, and which is not effected by a high magnesium oxide content in the ore.

### SUMMARY OF THE INVENTION

The present invention entails a method of forming phosphoric acid from phosphate ore by feeding the ore together with carbon source, which contains sulfur or carbon plus sulfur, to a kiln where the mixture is heated to reduce tricalcium phosphate occurring in the ore to a phosphorus gas. The resulting phosphorus gas reacts with oxygen to form phosphorus pentoxide. Thereafter the phosphorus pentoxide is converted to phosphoric acid.

In the preferred method, the carbon source and sulfur are taken from a group comprising coal, coal coke, or petroleum coke. The chosen coke, silica and binder are mixed with the phosphate ore through pulverizing, blending, and moistening to form ore pellets. The pellets are preheated to a temperature of approximately 300 to 500° C. before being directed into a ported rotary kiln. In the kiln, the pellets are heated to a temperature of approximately 1200° C. to 1375 ° C. for a period of approximately 2 to 4 hours. The heating of the ore pellets results in the production of phosphorus gas, which reacts with oxygen to form phosphorous pentoxide. This gas is then reacted with water in a scrubber to produce phosphoric acid.

Other objects and advantages of the present invention will become apparent and obvious from a study of the following description and the accompanying drawings, which are merely illustrative of the invention.

### BRIEF DESCRIPTION OF THE DRAWINGS

FIG. 1 is a block diagram illustrating the reduction processing of phosphate ore that leads to the production of phosphoric acid.

FIG. 2 illustrates the impact of various levels of sulfur in converting phosphate ore to phosphoric acid.

### DETAILED DESCRIPTION OF THE INVENTION

The present invention relates to a process for manufacturing phosphorus pentoxide from a phosphate ore and combining or mixing water with the phosphorus pentoxide to form phosphoric acid. Basically, the present invention entails mixing phosphate ore with silica, a carbon source and sulfur to form an ore mixture. The ore mixture, in one embodiment, is pelletized to form the ore mixture into pellets. Thereafter, the pellets may be preheated and then directed into a kiln. Once in the kiln, the ore pellets are heated and, in the course of heating, the phosphorus in the ore is converted to phosphorus gas and then to phosphorus pentoxide. The phosphorus pentoxide is directed from the kiln to an absorber and combined with water to form phosphoric acid. As will be discussed subsequently herein, the carbon source which can have sulfur added to it or preferably a carbon source containing sulfur is added with other ingredients added to the phosphate ore is effective in increasing the efficiency of the phosphoric acid production. More particularly, the sulfur added to the ore, which is usually present in the carbon source acts as a catalyst.

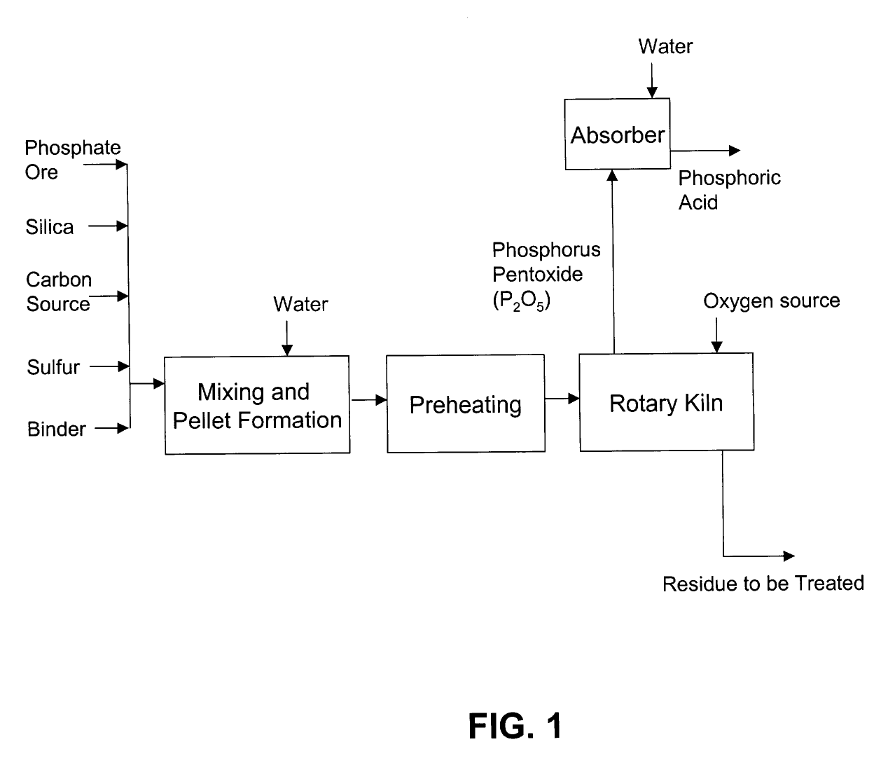

In the wet acid industry it is desirable to concentrate the phosphate fraction of the ore from about 16% to 30% to minimize the sulfuric acid consumption. In contrast the present invention eliminates the need for sulfuric acid and makes it possible to use ores with 20% P₂O₅ content thus reducing beneficiation requirements and enabling the use of ore with high magnesium oxide content. Turning specifically to the process of the present invention, and with reference to FIG. 1, it is seen that, in one embodiment, the phosphate ore is mixed with silica, a carbon source, and sulfur. The bulk of the mixture is the phosphate ore, with sulfur comprising approximately 0.5% to 4% of the ore mixture, however an ore mixture comprising greater than 4% sulfur can be used in the present invention. The silica and carbon are initially added to the process, while sulfur can be directed to the process at or before the kiln. Preferably, the sulfur is combined with the phosphate ore prior to being directed into the kiln. Also, in most cases, the sulfur would be present in the carbon source mixed with the phosphate ore. However, it should be appreciated that the sulfur could be directed into the kiln where it would react with the tricalcium phosphate in the phosphate ore. In one embodiment of the present invention, it is contemplated that the carbon source will comprise petroleum coke. Low level sulfur petroleum coke will generally consist of between 0% and 3% sulfur, while high level sulfur petroleum coke will generally consist of 3% to 8% sulfur. As used herein, the term low level sulfur means a sulfur content within petroleum coke of 0% to 3%. The term high level sulfur means a sulfur content in petroleum coke of 3% to 8%. The phosphate ore is pulverized and beneficiated to remove impurities such as clay, iron, sodium, potassium and alumina that are present in the ore prior to mixing with the reactants. In one embodiment, the ore mixture is ground and pressed into pellets using known techniques and methods, such as a bailing drum, a disk pelletizer, or an extruder.

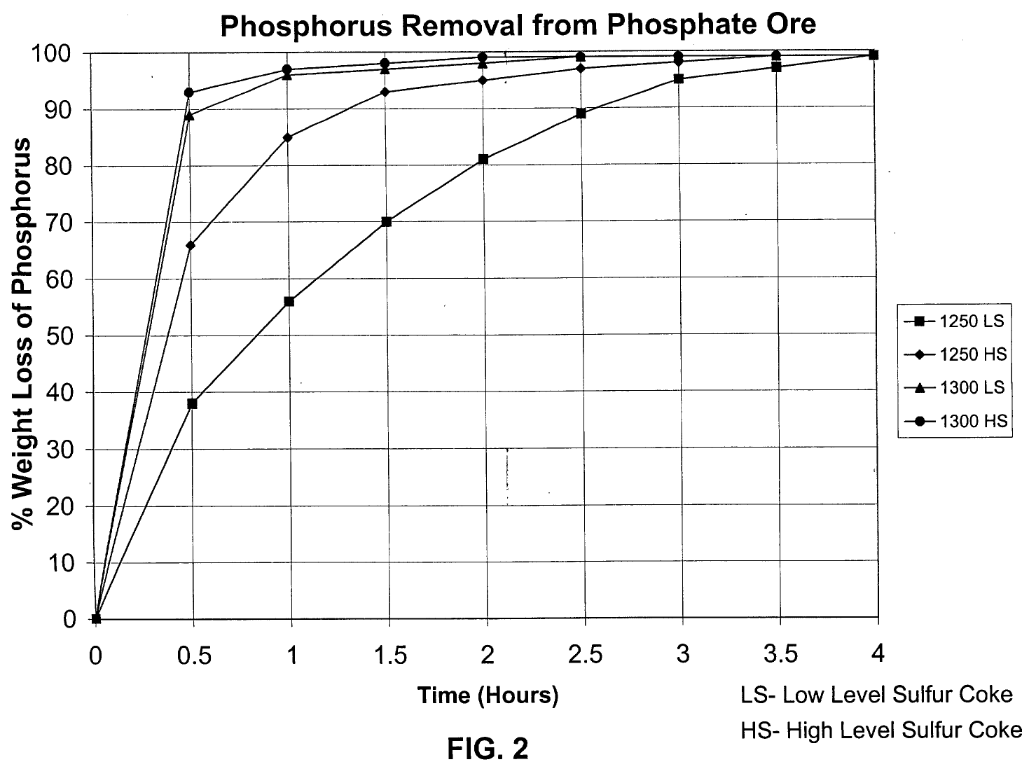

When phosphate ore is mined from the earth, it typically contains, after beneficiation, calcium oxide (CaO), phosphorus pentoxide (P₂O₅), silicon dioxide (SiO₂), magnesium oxide (MgO), aluminum oxide (Al₂O₃), iron oxide (F₂O₃), and other minor constituents. In one embodiment, when silica is mixed with the phosphate ore, the mole ratio of calcium oxide to silica is adjusted to a ratio of approximately 1.3 to 2.2 by the addition of silica or sand that maybe recovered from beneficiation. Generally, the recovered sand contains about 90% silica, 6% calcium oxide and 4% phosphorus pentoxide. In mixing the petroleum coke with the phosphate ore, sufficient petroleum coke is added to give a carbon to oxygen mole ratio of approximately 2.4 to 3.0 times the stoichiometeric quantity required to remove oxygen. As will be discussed subsequently herein, petroleum coke containing various sulfur levels ranging from some over 0% to 8% are suitable for the reduction of the phosphate ore. As can be seen from the graph on FIG. 2 the higher the sulfur content in the carbon source the more the efficiency of the removal occurs both in terms of phosphorous extraction and in the reduction of the reaction temperature than experienced in similar processes. In some cases, a binder such as bentonite or lignosulfate can be added to increase pellet strength. Once the ore mixture has been properly adjusted, the resulting pulverized material may be moistened for pelleting or balling. Here approximately 15 parts of water to 100 parts of dry ore mixture maybe used.

After the ore mixture has been pelletized or balled, the material is preheated to about to 300 to 500° C. on a traveling grate or vibrating fluid bed dryer/heater before being directed into a rotary kiln.

After being preheated, the pellets are directed into the kiln, in the case of a preferred embodiment, a ported rotary kiln. The temperature within the kiln is maintained within a temperature range of approximately 1200° to 1375° C. and the pellets are subjected to a residency time of 1.5 hours to 5 hours within the kiln. Various types of kilns may be used but it is contemplated that in a preferred embodiment a ported rotary kiln would be utilized. In such a kiln, the feed material or pelletized ore is placed within a ported-type rotary kiln. Such kilns are well known and appreciated by those skilled in the art and are described in U.S. Pat. Nos. 3,182,980; 3,847,538; 3,945,824; and 4,070,149. The disclosures of these four patents are expressly incorporated herein by reference.

Ported-rotary kilns achieve uniform or near uniform temperature distribution by means of multiple spaced-apart ports in the kiln walls, which allows fuel and air to be fired evenly over and across the length of the kiln bed. It should be noted that uniform temperature distribution is desirable because in cases where there is a non-uniform temperature distribution along the length of a kiln may result in fusing or melting of the ore pellets. However the ported kiln may be used with a single gas burner located at one end of the kiln. In both configurations, inert gas is fed through the ports under the phosphate ore bed. As a third alternative the process can be operated using a kiln that does not have ports and which is fitted with a single gas burner.

As noted above, once placed in the kiln, the ore pellets are subjected to elevated temperatures where the carbon and sulfur within the ore mixture reacts with tricalcium phosphate contained within the pellets through reduction type reactions to form carbon monoxide, sulfur dioxide and phosphorus gas. In the case of a ported-kiln, the ports in the kiln allow air to enter the kiln and effectively oxidize the phosphorus gas and carbon monoxide reaction products. As a result of these oxidation reactions, the phosphorus gas is converted to phosphorus pentoxide (P₂O₅) while the carbon monoxide is converted to carbon dioxide (CO₂). The exothermic heat generated from these two oxidation reactions essentially balances the endothermic heat required for the reduction of the phosphate ore. The same ports which allow air to enter the upper area of the kiln may be utilized to allow inert gas such as nitrogen or nitrogen and carbon dioxide to enter beneath the tumbling bed in order to reduce the partial pressure of the carbon monoxide formed and to provide a boundary layer of inert gas above the pellets to minimize carbon burnout. An embodiment of producing phosphorus pentoxide from phosphate ores by heating the ore in a rotary-type kiln is described by Megy in U.S. Pat. No. 4,351,813 and this patent is expressly incorporated herein.

As a consequence of the reduction reaction and subsequent oxidation reactions described above, the exhaust gas stream leaving the kiln contains primarily carbon dioxide, nitrogen and phosphorus pentoxide. Further, the exhaust gas stream contains a small amount of sulfur dioxide (SO₂) released from the sulfur present in the ore mixture, hydrogen fluoride (HF), and entrained particulate. In order to remove the entrained particulate, which could contaminate the phosphoric acid produced by the present process, a ceramic-lined cyclone collector can be installed in the exhaust gas stream duct to remove substantial portions of the particulate, while a ceramic filter downstream from the cyclone collector may further filter the dust and particulate matter in the exhaust stream.

After particulate matter has been removed from the exhaust gas stream, the exhaust gas stream is quenched with recycled phosphoric acid in a quench chamber located upstream from an absorber to a wet-bulb temperature of about 150° F. before entering the absorber. The phosphorus pentoxide in the exhaust gas stream is converted to phosphoric acid in a conventional fashion such as through a multi-tray absorber. Phosphoric acid leaving the absorber will typically have a concentration range from 50%-60% phosphoric acid. A filter can be utilized to filter solid materials in the phosphoric acid before the phosphoric acid is directed into an evaporator for concentrating the phosphoric acid into a technical grade acid containing a phosphoric acid concentration of 73% or greater.

Further, the sulfur dioxide and hydrogen fluoride gases present in the exhaust gas stream pass from the absorber with the nitrogen and carbon dioxide. In typical processes, the ore may contain about 3% fluorine and in those cases, approximately 10-20% of the fluorine present is released as hydrogen fluoride gas. The gas stream leaving the absorber passes through a lime scrubber in which the lime typically reacts with sulfur dioxide to form calcium sulfate and with the hydrogen fluoride gas to form calcium fluoride.

Spent residue leaving the rotary kiln may be cooled in an inert gas atmosphere to avoid combustion of the excess carbon present. Excess unreacted carbon in the residue is separated from the lime and silica in order to recycle the carbon. The final residue, consisting primarily of lime and silica, may serve as a raw material for various industries such as the cement industry.

### EXAMPLE 1

In one example of the present invention, the material mix contained 68.8% phosphate ore, 7.8% silica, and 23.4% petroleum coke. The phosphate ore as analyzed contained 40.51% CaO, 24.05% P₂0₅, 11.75% SiO₂, 3.5% MgO, and 2.8% Fluorine. The silica contained 98% SiO₂. The petroleum coke had a fixed carbon content of 85.5% and 7% sulfur. The ore mix was grounded to where 75% of the mix passed a 200-mesh screen. These materials were blended with 15 parts of water and extruded in a bench scale extruder into ¼ inch diameter pellets of about ⅜ inch length. The pellets were dried overnight in an oven maintained at 210° F. The dried pellets were placed in a 100 ml crucible and placed in an electric furnace. The following results were obtained and plotted on a graph (see FIG. No. 2).

| Temperature | Time Held at Temp. | |
|---|---|---|
| ° C. | Hours | % Phosphorus Removal |
| 1250 | 2 | 96.6 |
| 1250 | 3 | 98.8 |
| 1300 | 1 | 97.7 |

### EXAMPLE 2

In this test the petroleum coke was reduced to 80% of that used in Example 1. The formulation contained 72.12% phosphate ore, 8.24% silica, and 19.04% high sulfur petroleum coke. The results were as follows:

| Ore | Pet Coke | Temperature | | % Phosphate |
|---|---|---|---|---|
| Mesh | Mesh | ° C. | Time at Temp. Hours | Removed |
| 200 | 150 | 1250 | 1 | 84.1 |
| 200 | 150 | 1250 | 2 | None Detected |
| 200 | 150 | 1300 | 1 | 96.7 |
| 200 | 150 | 1300 | 2 | None detected |
| 150 | 150 | 1300 | 1 | None detected |
| 150 | 150 | 1300 | 2 | None detected |

These results showed that a coarser grind of ore and reduction of pet coke gave similar results. This allows lower use of energy for grinding. A further reduction of pet coke resulted in marked reduction of mechanical strength of the pellets together with melting.

As illustrated in FIG. 2, the addition of sulfur increases the efficiency of phosphoric acid production. In particular, as the sulfur levels in the ore mix were increased for a given temperature, there was an increase in the percent weight loss of phosphorus. Moreover, the inclusion of sulfur in the ore mix reduced the time required to reach a certain level of percent weight loss in the ore. In one case, the ore was mixed with a low level of sulfur and heated to 1250° C. (See plot 1250 LS). A desirable percent weight loss level (98%) was reached after 4 hours of heating. In another case, the ore was mixed with a high level of sulfur and also heated to 1250° C. (See plot 1250 HS). Here, the desirable level of percent weight loss was reached after 2.5 hours of heating, thus decreasing the residency time of ore within the kiln. In another case, the ore was mixed with a low level of sulfur and heated to 1300° C. (See plot 1300 LS). A desirable level of percent weight loss was reached after 1.5 hours of heating. Finally, in another case, the ore was mixed with a high level of sulfur and also heated to 1300° C. (See plot 1300 HS). A desirable level of percent weight loss was reached after 1 hour of heating, again demonstrating that higher levels of sulfur within the process decrease the residency time of the ore within the kiln.

Further, the addition of sulfur allows the process to operate at lower temperatures than conventional processes, thus conserving energy and heating time. The melting point of sulfur (444° C.) is surpassed by the temperatures present in the kiln, thus promoting liquefaction of the sulfur present in the ore mix. The liquefaction can take place within the kiln; however, liquefaction of the sulfur in the phosphate ore mixture may take place in a preheating stage prior to entry into the kiln. Here, the liquefaction of sulfur enhances the sulfur's ability to react with the tricalcium phosphate, thus allowing the temperatures within the kiln to be reduced while reaching desired levels of phosphorus gas production. In the embodiment of FIG. 2, sulfur addition permitted a desirable phosphorus percent weight loss of 98% at a temperature of 1300° C. A preferred temperature range for the extraction of phosphorus within the kiln is 1250° C. to 1375° C., however extraction is possible at temperatures below and above this range. Utilizing higher temperatures within the range allows the phosphorus to be extracted in a shorter duration while achieving desirable percent weight losses.

In addition the process allows use of ore containing high levels of MgO. Since the MgO stays in the solid state. The MgO is left in the solids residue and does not contaminate the phosphoric acid at the absorber. Ores containing 5% MgO and higher have been tested and have shown to have no effect on the production of the phosphoric acid.

The present invention may be carried out in other specific ways than those herein set forth without parting from the spirit and essential characteristics of the invention. The present embodiments are, therefore, to be considered in all respects as illustrative and not restrictive, and all changes coming within the meaning and equivalency range of the appended claims are intended to be embraced therein.

1. A method of producing phosphoric acid from phosphate ore comprising: mixing a carbon source, sulfur and silica with the phosphate ore to form a phosphate mixture; mixing sufficient quantities of the sulfur with the phosphate ore mixture to where the sulfur makes up approximately 0.5 to 4.0 percent of the phosphate mixture by weight; heating the mixture to a temperature of 1200° C.-1375° C.; reacting the sulfur, silica and carbon with the phosphate ore such that the resulting reactions of both carbon and sulfur with the phosphate ore reduce the phosphorous content in the phosphate ore by 95% to form phosphorous gas which is ultimately oxidized to phosphorus pentoxide; and wherein the reduction of the phosphate ore occurs within said temperature range and within a residency time period of two hours or less.

2. The method of claim 1 wherein the sulfur is mixed with the phosphate ore prior to heating.

3. The method of claim 2 wherein the sulfur is contained within a carbon source.

4. The method of claim 1 wherein the phosphate ore mixture is directed into a rotary kiln for heating.

5. The method of claim 1 wherein the carbon source is petroleum coke and wherein the petroleum coke comprises sulfur which makes up approximately 3-12 percent of the petroleum coke

6. A method of producing phosphoric acid from phosphate ore comprising mixing silica and a petroleum coke to form a phosphate mixture wherein the petroleum coke includes a high level sulfur content; reacting the sulfur within the petroleum coke with at least a portion of the phosphate ore mixture to produce phosphorous gas which is ultimately oxidized to form phosphorous pentoxide and converting the phosphorous pentoxide to phosphoric acid.

7. The method of producing phosphoric acid of claim 6 wherein the sulfur comprises approximately 3 to 12 percent of the petroleum coke.

8. The method of producing phosphoric acid of claim 6 wherein the sulfur found in the petroleum coke comprises approximately 0.5-4.0 percent of the phosphate ore mixture.

9. The method for producing phosphoric acid of claim 6 including liquefying the sulfur to enhance its reaction with the phosphate ore.

10. The method of claim 9 wherein liquefying the sulfur takes place in a preheating step.

11. The method in claim 1 wherein the excess carbon present in the residue is reclaimed and recycled.

12. The method of claim 11 wherein the non-carbon residue is used as a raw material for cement manufacture.
